(19) United States
(12) Patent Application Publication
(10) Pub. No.: US 2015/0316036 A1
(43) Pub. Date: Nov. 5, 2015

(54) GENERATOR OF DIRECTIONAL THRUST FOR MOVING VEHICLES AND/OR OBJECTS IN GENERAL USING CENTRIFUGAL FORCE

(71) Applicants: Junior OSWALDO STOPPA, Sao Paulo (BR); Oswaldo STOPPA, São Paulo (BR); Paulo Marcelo BARBIERI, São Paulo (BR); Paulo Roberto Dias MENEZES, (US); Salvador ANGERAME, São Paulo (BR)

(72) Inventors: Junior OSWALDO STOPPA, São Paulo (BR); Oswaldo STOPPA, São Paulo (BR); Paulo Marcelo BARBIERI, São Paulo (BR); Paulo Roberto Dias MENEZES, São Paulo (BR); Salvador ANGERAME, São Paulo (BR)

(21) Appl. No.: 14/440,403

(22) PCT Filed: Nov. 5, 2012
(86) PCT No.: PCT/BR2012/000430

§ 371 Date: May 4, 2015

(51) Int. Cl. F03G 3/08

(52) U.S. Cl. CPC F03G 3/08

(57) ABSTRACT

A thrust generator developed for use in vehicles in general such as bicycles, motorcycles, motor cars and aircraft, as well as for other uses such as in wheelchairs, elevators or any other objects that require movement and/or fluctuation, the movement generator including a circular element having two portions of differing radius, in which an upper portion has a substantially semicircular circumference and a lower portion is substantially semi-elliptical, thereby establishing a circuit through which move peripheral sliding elements of equal weight and mass that rotate about a circular element in circular movements that provide different speeds to the sliding elements as a function of the stretch they are moving on, generating a directional vector and moving the unit and keeping it in movement or suspended in the air in a state of fluctuation and/or in a state of simultaneous fluctuation with movements, using the principles of centrifugal force.

### CROSS-REFERENCE TO RELATED APPLICATIONS

This application claims priority to PCT Application No. PCT/BR2012/000430, having a filing date of Nov. 5, 2012, the entire contents of which are hereby incorporated by reference.

### FIELD OF TECHNOLOGY

The following refers to a thrust generator belonging to the field of devices or mechanisms producing mechanical forces using different energy sources.

This concept was specifically developed to be applicable to objects that may be moved, whether they are vehicles in general such as bicycles, motorcycles, automobiles and aircrafts, as well as for other miscellaneous uses, such as application in wheelchairs, elevators and for any other objects requiring moving and/or fluctuation.

Said motion generator, appropriately constructed according to the concepts described in this patent, is capable of maintaining the element to where it is applied in motion or suspended in the air, in a fluctuation state and/or in a fluctuation state with simultaneous upward, downward, forward and backward movements, and around its latitudinal axis, using the principles of the centrifugal force as a working means.

### BACKGROUND

As known by professionals and scholars of physics, it is known that a force consists of any action or influence able to modify the state of motion or rest of a body or of an established situation, as well as to impose acceleration to it modifying its speed.

To establish this force and generate movements on objects and vehicles, its propulsion means together with usually mechanical means may be manual, as can be easily noticed on bikes, tricycles, wheelchairs, among others, which traction is human, and the vast majority of motorcycles and cars existing in the state of the art are provided with combustion engines as propulsion means.

Additionally, electrical power generation means are provided for the movement, which may move various objects such as toys, wheelchairs and hybrid vehicles that are moved by the electrical energy generated by batteries and other alternative energy sources.

The motion generators applied to aircrafts, for example, comprise more complex propulsion means, so that said aircrafts can be maintained in the air, namely, the sustentation of an aircraft in the air must be equal to its weight, and however, for said aircraft to take off, a greater sustentation than its own weight will be necessary.

Generally, with respect to the aircrafts, single-engine, twin-engine and turbo-propellers are considered, that make use of a motor that turns a propeller creating the thrust needed to move the aircraft forward.

In particular, turbo-propellers are movement generators, said movement obtained by reaction engines (jet) that drive a propeller. On the other side, jet aircrafts make use of turbines to generate the necessary thrust to move the aircrafts forward and they provide much more power, creating a much bigger thrust than aircrafts that use turbo-propellers.

Said turbo-propeller is a type of gas turbine of mixed reaction, because it is, basically, a jet engine that activates a propeller, and between the turbine shaft and the propeller there is installed a speed reducer. The propulsive force of this engine is 90% produced by the propeller and 10% by the exhaust gases.

A reaction motor, also known as jet engine or only as reactor, is an engine that ejects a rapid stream of a fluid to generate a thrust force in accordance to Newton's Third Law. This broad definition of a jet engine includes turbojets, turbofans, rockets and static reactors. In general, the term refers to a gas turbine which ejects a jet at high speed generating thrust and, consequently, generating a propulsion force for various applications.

The thermojet is the most primitive type of jet engine, consisting essentially of a turbocharged piston motor with a typical jet exhaust pipe, having the advantage of a greater thrust speed than a motor with a propeller and a better thrust at high speeds, but on the other side, it is heavy, inefficient and low powered.

The turbojet is a generic term for an aircraft with a single turbine, presents structural simplicity, however, loses much in efficiency and power.

Regarding the forces required to achieve the displacement of an object, vehicle and/or aircraft, it should be understood that when a body of any type moves in a curved path, it is doing a forced movement because, according to Newton's First Law, also known as Law of Inertia, every body has an inertia that keeps it in its initial state, whether it is a rest state or an uniform rectilinear movement.

Consequently, a body moving over a circular path suffers the action of some force to keep its uniform straight course. The force acting on it consists of a centripetal force, which is directed to the center of the circle where its trajectory is described.

This centripetal force is the product of the mass of the body times its centripetal acceleration, given by: ac=v²/R, where v is the velocity of the body at the point of the trajectory at which we want to know its speed, and R is the radius of the circle over which it executes its movement. Said acceleration is an immediate reaction force that tends to throw the body “on the tangent”, which is the path that the body would tend to do naturally.

In a curved trajectory, the centrifugal force acts from the center to the periphery, balancing the centripetal force.

The value of the difference between the normal and resulting centripetal is constant, so the more one decreases the speed of the body, the more decreases the value of the normal. To minimize the left side of the equation and to leave the vehicle/aircraft balanced, the normal force must be equal to zero and the resulting centripetal force must be equal to the weight force.

### SUMMARY

From all the above information about the operation of aircrafts and the definitions regarding displacement forces, and also due to the lack of a compact aircraft with simplified handling, the inventor has created and developed this “GENERATOR OF DIRECTIONAL THRUST FOR MOVING VEHICLES AND/OR OBJECTS IN GENERAL USING CENTRIFUGAL FORCE” which should personalize itself to the consumer market by the fact that it reveals a thrust or directional movements generator, applicable to many objects that can be moved, whether they are vehicles in general such as bicycles, motorcycles, automobiles and aircrafts in general, as well as for other miscellaneous uses, such as application in wheelchairs, elevators and any other objects requiring moving and/or fluctuation, said motion generator being capable of maintaining the object where it is to be used, in motion or suspended in the air, in a fluctuating state and/or in a fluctuating state with simultaneous upward, downward, forward and backward movements, and around its latitudinal axis, using the principles of the centrifugal force as a working means.

The concept of the thrust generator, object of this patent, consists generally of an assembly of sliding elements of same mass and weight, which rotate around an axis, with a centrifugal movement, travelling at an uneven path which generates a directional and perpendicular vector to said axis, displacing the whole assembly into the direction of said vector. The mentioned sliding elements act in a circular manner and are guided by a radius limiter, and the distance between the two points of the diameter of the circumference of the upper portion is greater than the distance between the two points of the same diameter at the lower portion.

This thrust generator may be activated by an electric motor, combustion engine or by any other appropriate ways of low cost that are adequate to make it usable.

Consequently, it follows that, the higher the rotating speed of the fluctuating sliding elements, the greater the ability to move and/or hold the vehicle in a fluctuating state.

### BRIEF DESCRIPTION

The subject matter of this invention will become entirely clear in its technical aspects from the detailed description which will be based on the related drawing below, in which:

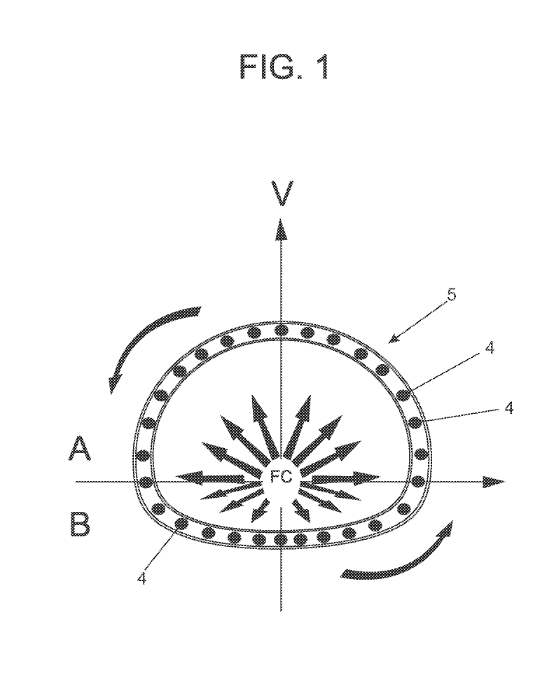

FIG. 1 shows, in a schematic form, the vector generated from the centrifugal force generated by the rotation of the sliding elements around the circular element;

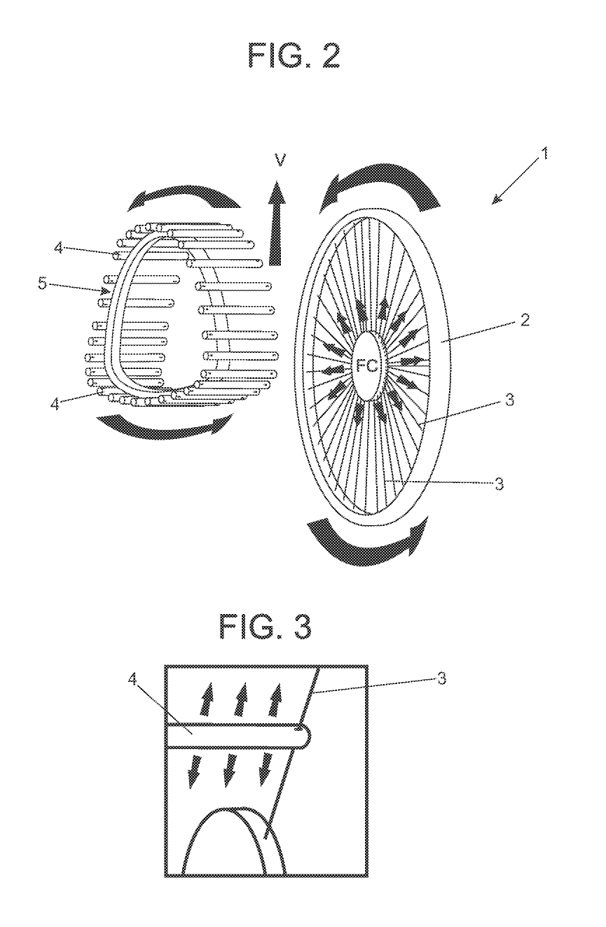

FIG. 2 shows, in a perspective view, the vector generated from the centrifugal force generated by the rotation of the sliding elements around the circular element; and

FIG. 3 shows a detail of a sliding element and its vector forces.

### DETAILED DESCRIPTION

According to the above mentioned drawings, the present invention “GENERATOR OF DIRECTIONAL THRUST FOR MOVING VEHICLES AND/OR OBJECTS IN GENERAL USING CENTRIFUGAL FORCE”, reveals a new thrust generator 1, whose concept was specifically developed to be applicable in vehicles in general whether they are bicycles, motorcycles, automobiles and aircrafts in general, as well as for other miscellaneous uses, such as application in wheelchairs, elevators and any other objects requiring moving and/or fluctuation.

Said motion generator 1 is capable of maintaining the element to where it is applied in motion or suspended in the air, in a fluctuation state, using the principles of the centrifugal force as a working means.

Conceptually, the concept of the directional thrust generator 1, object of this patent, consists generally of at least one circular element 5 shown in two portions A and B of different radius, wherein the upper portion A provides a substantially semicircular circumference and the lower portion B a substantially semi-elliptical complexion, establishing in that way a circuit in which sliding peripheral elements 4 move, of same weight and mass, which rotate around a circular element 5 with circular movements that provide distinctive speeds to said sliding elements 4, as a function of the trajectory they move along, generating a directional vector V and moving the assembly 1.

Consequently, said motion generator 1 provides at least one assembly equipped with a first circular element 2 of uniform radius, this one provided with radial shafts 3 where a plurality of sliding elements 4 move, a second circular element 5, this one divided in two distinct portions A and B, the upper part A presenting a radius that configures a substantially semicircular element and the lower part B providing a substantially elliptical radius.

The sliding elements 4 are coupled, at one side, on each of the radius of the first circular element sliding through its entire length and, on the other side, at its opposite ends, they run through the circuit formed by the second circular element.

Consequently, the sliding elements 4 move along the circuit formed on the periphery of the second circular element 5, moving with a rotating movement around said second circular element 5, said sliding elements 4 may be displaced in the rotating direction of this circular element 5, moving consequently the whole assembly 1 in the direction in which said sliding elements 5 are displaced.

This vector movement V (like on the wings of an airplane the air molecules travel a longer distance on the upper surface (top side of the wing) and a shorter distance on the lower surface (underside thereof), and according to the Bernoulli's Theorem of Flow Equation, consequently the air molecules reach a higher speed on the upper surface in relation to the speed achieved by the air molecules on the lower surface, resulting in an upward vector), occurs by the fact that the displacement of the sliding elements 4, when they move along the lower portion B, occur at a slower speed that when they move along the portion A, creating a directional vector V and consequently promoting its movement and allowing that way, as a function of the rotating speed applied to the assembly, its floatability.

The sliding elements 4 move, on the upper portion A, a longer distance than on the lower portion B and, since both portions A and B rotate at the same speed (RPM), and consequently said sliding elements 4 reach a higher speed to move along of all the upper portion A of the circuit and a lower speed to move along the portion B of said circular element 5, causing a greater and stronger centrifugal force FC to be exerted on the sliding elements 4 when they move along the upper portion A, and a smaller centrifugal force FC on the lower portion B of the circuit.

The mentioned sliding elements V operate in a circular manner and are guided by a radius limiter, and the distance between the two points of the diameter on the circumference of the of the upper portion A is greater than the distance between the two points of the same diameter on the lower portion B, thereby generating unequal trajectories and speeds. Said directional thrust generator 1 may be activated by different propulsion means, such as, for example, an electric motor, a combustion engine or even by any other appropriate ways of low cost that are adequate to make it usable.

In order to promote the simultaneous fluctuation with upward, downward, forward and backward movements and around its latitudinal axis, there are needed, at least, two devices 1 installed on the same frame or chassis, one device 1 rotating in a clockwise direction and the other one rotating in an opposite or counter-clockwise direction, since, like with helicopters, in the same way the tail rotor cancels the counter-rotation of the fuselage or the helicopter body, in the opposite rotation direction of the main rotor, in the case of the generator 1 of centrifugal thrust, now claimed by the applicant, a second device 1 nullifies the counter-rotation of the frame in which the first device is installed.

Two sets of two devices totalizing four devices are installed on the same frame or chassis, where two devices 1 rotate in a clockwise direction and two in a reverse or anti-clockwise direction, and they allow, besides the simultaneous fluctuation with upward, downward, forward and backward movements and around its latitudinal axis, to add, also simultaneously to the fluctuation, sideway and diagonal movements and around the longitudinal axis.

Although the detailed description of the present invention, it is important to understand that it does not limit its application to the details and steps herein described. The invention is capable of other embodiments and of being practiced or performed in a variety of ways. It should be understood that the terminology used herein was used for description purposes and is not intended to limit the present invention.

1. A generator of directional thrust for moving vehicles and/or objects in general using centrifugal force, developed to be applicable in vehicles in general such as bicycles, motorcycles, automobiles and aircrafts in general, as well as for other miscellaneous uses, such as application in wheelchairs, elevators and any other objects requiring moving and/or fluctuation, the directional thrust generators comprising:
at least one circular element of different radius, wherein an upper portion provides a substantially semicircular circumference and a lower portion having a substantially semi-elliptical complexion, establishing in that way a circuit in which a plurality of sliding peripheral elements move, of same weight and mass, which rotate around the at least one circular element with circular movements that provide distinctive speeds to the plurality of sliding peripheral elements, as a function of the trajectory they move along, generating a directional vector and moving the assembly.

2. The generator according to claim 1, wherein the directional thrust generator comprises at least one assembly equipped with a first circular element of uniform radius, this one provided with radial shafts where a plurality of sliding elements move, a second circular element, this one divided in two distinct portions, the upper part presenting a radius that configures a substantially semicircular element and the lower part providing a substantially elliptical radius; the sliding elements are coupled, at one side, on each of the radius of the first circular element sliding through its entire length and, on the other side, at its opposite ends, they run through the circuit formed by the second circular element; consequently, the sliding elements move along the circuit formed on the periphery of the second circular element, moving with a rotating movement around said second circular element, said sliding elements may be displaced in the rotating direction of this circular element, moving consequently the whole assembly in the direction in which said sliding elements are displaced.

3. The generator according to claim 1, wherein the displacement of the plurality of sliding peripheral elements, when they move along the lower portion, occur at a slower speed that when they move along the portion, creating a directional vector.

4. The generator according to claim 1, wherein as a function of the design of the circuit, a greater and stronger centrifugal force will be exerted on the plurality of sliding peripheral elements when they move along the upper portion and a smaller centrifugal force on the lower portion of the circuit.

5. The generator according to claim 1, wherein the plurality of sliding peripheral elements operate in a circular manner and are guided by a radius limiter, and the distance between the two points of the diameter on the circumference of the of the upper portion is greater than the distance between the two points of the same diameter on the lower portion, thereby generating unequal trajectories and speeds.

6. The generator according to claim 1, wherein the directional thrust generator is activated by different propulsion means, such as, for example, an electric motor, a combustion engine or even by any other appropriate ways.

7. The generator according to claim 1, wherein there are needed, at least, two devices installed on the same frame or chassis to enable the fluctuation, one device rotating in a clockwise direction and the other one rotating in an opposite or counter-clockwise direction, and the second device nullifies the counter-rotation of the frame in which the first device is installed.

8. The generator according to claim 1, wherein there are provided two sets of two devices totalizing four devices installed on the same frame or chassis, where two devices rotate in a clockwise direction and two in a reverse or anti-clockwise direction, allowing, besides the simultaneous fluctuation with upward, downward, forward and backward movements and around its latitudinal axis, to add, also simultaneously to the fluctuation, sideway and diagonal movements and around the longitudinal axis.

9. The generator according to claim 1, wherein the plurality of sliding peripheral elements have equal weight and mass.
